(19) United States
(12) Patent Application Publication
(10) Pub. No.: US 2010/0209339 A1
(43) Pub. Date: Aug. 19, 2010

(54) SILICON-TITANIUM MIXED OXIDE POWDER, DISPERSION THEREOF AND TITANIUM-CONTAINING ZEOLITE PREPARED THEREFROM

(75) Inventors: Kai Schumacher, Hofheim (DE); Martin Moerters, Rheinfelden (DE); Helmut Mangold, Rodenbach (DE); Steffen Hasenzahl, Hanau (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Degussa, Essen (DE)

(21) Appl. No.: 12/678,595

(22) PCT Filed: Sep. 25, 2008
(86) PCT No.: PCT/EP2008/062826

§ 371 Date: Mar. 17, 2010

(30) Foreign Application Priority Data
Oct. 16, 2007 (DE) 10 2007 049 743.3

(51) Int. Cl. C01B 39/02

(52) U.S. Cl. 423/700

(57) ABSTRACT

Pyrogenic silicon-titanium mixed oxide powder having • a BET surface area of 200 to 400 m²/g, • a DBP number/BET surface area ratio of 0.5 to 1.2, • a silicon dioxide content of 93.5 to 95.4% by weight and a titanium dioxide content of 4.6 to 6.5% by weight, where the sum of the contents is greater than 99.7% by weight. Dispersion comprising the pyrogenic silicon-titanium mixed oxide powder. Process for preparing a titanium-containing zeolite proceeding from powder or dispersion.

The invention relates to a pyrogenic silicon-titanium mixed oxide powder and to the preparation thereof.

The invention further relates to a dispersion comprising the pyrogenic silicon-titanium mixed oxide powder.

The invention further relates to a process for preparing a titanium-containing zeolite by means of the pyrogenic silicon-titanium mixed oxide powder or a dispersion comprising this powder. The invention further relates to the titanium-containing zeolites obtainable by this process and to their use as a catalyst.

EP-A-814058 discloses the use of silicon-titanium mixed oxide powders for preparing titanium-containing zeolites. Titanium-containing zeolites are efficient catalysts for the oxidation of olefins with hydrogen peroxide. They are obtained by a hydrothermal synthesis proceeding from silicon-titanium mixed oxide powders in the presence of a template. EP-A-814058 discloses that pyrogenic silicon-titanium mixed oxides having a silicon dioxide content of 75 to 99.9% by weight and a titanium dioxide content of 0.1 to 25% by weight can be used for this purpose. A particularly advantageous composition is one which comprises 90 to 99.5% by weight of silicon dioxide and 0.5 to 5% by weight of titanium dioxide. The templates used may be amines, ammonium compounds or alkali metal/alkaline earth metal hydroxides.

A disadvantage of the process disclosed in EP-A-814058 is the long reaction time which is required for the conversion of the silicon-titanium mixed oxide in the presence of the template. Moreover, not all titanium-containing zeolites obtained according to EP-A-814058 have a sufficient catalytic activity.

It was therefore an object of the invention to provide a silicon-titanium mixed oxide with which the reaction times in the preparation of the titanium-containing zeolite can be reduced. It was a further object of the invention to provide a titanium-containing zeolite with high catalytic activity.

The invention provides a pyrogenic silicon-titanium mixed oxide powder, in which
the BET surface area is 200 to 400 m²/g and
the ratio of DBP number/BET surface area is 0.5 to 1.2, and
which has a silicon dioxide content of 93.5 to 95.4% by weight and a titanium dioxide content of 4.6 to 6.5% by weight, where the sum of silicon dioxide content and titanium dioxide content is greater than 99.7% by weight, where all percentages are based on the total amount of the powder.

“Pyrogenic” is understood to mean mixed metal oxide particles obtained by flame oxidation and/or flame hydrolysis. Oxidizable and/or hydrolysable starting materials are generally oxidized or hydrolysed in a hydrogen-oxygen flame. The inventive mixed metal oxide particles are very substantially pore-free and have free hydroxyl groups on the surface. They are present in the form of aggregated primary particles.

It has been found that a high BET surface area significantly reduces the duration to prepare a titanium-containing zeolite from the inventive silicon-titanium mixed oxide powder.

The DBP number (DBP=dibutyl phthalate) is a measure of the structure or the degree of coalescence of the particles of the powder and its dispersibility. The inventive powder has good dispersibility. In the present invention, the DBP number/BET surface area ratio is 0.5 to 1.2, preferably 0.8 to 1.1. The unit of this parameter is (g/100 g)/(m²/g). The DBP number/BET surface area ratio for pure pyrogenic silicon dioxide powders is >1.2. For example, the ratio for AEROSIL® 200 is approx. 1.5, and that for AEROSIL® 300 is approx. 1.3 (both Evonik Degussa).

Preference is given to an inventive silicon-titanium mixed oxide powder with a BET surface area of 250 to 350 m²/g and more preferably one of 300±30 m²/g.

Preference is further given to a silicon-titanium mixed oxide powder having a silicon dioxide content of 94 to 95% by weight and a titanium dioxide content of 5 to 6% by weight, where the sum of silicon dioxide content and titanium dioxide content is greater than 99.9% by weight. Particular preference is given to a silicon-titanium mixed oxide powder having a silicon dioxide content of 95.0±0.25% by weight and a titanium dioxide content of 5±0.25% by weight, where the sum of silicon dioxide content and titanium dioxide content is greater than 99.9% by weight.

The sum of silicon dioxide content and titanium dioxide content in the inventive powder is greater than 99.7% by weight and preferably greater than 99.9% by weight. The content of the metals Al, Ca, Co, Fe, K, Na, Ni and Zn is preferably less than 50 ppm each and more preferably less than 25 ppm each. The content of chloride is preferably less than 700 ppm. It has been found to be advantageous for the preparation of titanium-containing zeolites when the contents of these metals and chloride do not exceed these values. These impurities may originate from the feedstocks and/or may be caused by the process.

The invention further provides a process for preparing the inventive silicon-titanium mixed oxide powder, in which
93.5 to 95.4 parts by weight, calculated as SiO₂, of a silicon chloride and 4.6 to 6.5 parts by weight, calculated as TiO₂, of a titanium chloride are evaporated and the vapours are transferred into a mixing chamber, and, separately therefrom, hydrogen and primary air are transferred into the mixing chamber,
then the mixture of the vapours of silicon chloride and titanium chloride, hydrogen-containing combustion gas and primary air is ignited in a burner and the flame burns into a reaction chamber,
in addition, secondary air is introduced into the reaction chamber, then the solid is removed from gaseous substances, and
subsequently, the solid is very substantially freed of halide-containing substances by a treatment with steam at temperatures of 250 to 700° C.,
where the amount of the feedstocks consisting of silicon chloride, titanium chloride, combustion gas, primary air and secondary air is selected so as to result in an adiabatic flame temperature T_{ad} for which 900° C.<T_{ad}<1300° C.,
where
T_{ad}=temperature of feedstocks+sum of the reaction enthalpies of the subreactions/heat capacity of the substances which leave the reaction chamber including silicon-titanium mixed oxide, water, hydrogen chloride, if appropriate carbon dioxide, oxygen, nitrogen, and if appropriate of the carrier gas if it is not air or nitrogen, the basis being the specific heat capacity of these substances at 1000° C.

The specific heat capacities can be determined, for example, with the aid of the VDI-Warmeatlas (Chapter 7.1 to 7.3 and 3.7, 8th edition).

The conversion of the silicon chlorides and titanium chlorides in the presence of oxygen and of a combustion gas affords silicon-titanium mixed oxide, water, hydrochloric acid, and carbon dioxide in the case of carbon-containing silicon and/or titanium compounds and/or carbon-containing combustion gases. The reaction enthalpies of these reactions can be calculated by means of the standard works known to those skilled in the art.

Table 1 states some selected values of reaction enthalpies of the conversion of silicon halides and titanium tetrachloride in the presence of hydrogen and oxygen.

More preferably, methyltrichlorosilane (MTCS, CH SiCl₃), trichlorosilane (TCS, SiHCl₃) and/or dichlorosilane (DCS, SiH₂Cl₂) and titanium tetrachloride can be used.

TABLE 1
Reaction enthalpies

| | kJ/mol |
|---|---|
| H₂ | −241.8 |
| SiCl₄ | −620.1 |
| SiHCl₃ | −659.4 |
| SiH₂Cl₂ | −712.3 |
| C₃H₇SiCl₃ | −2700.2 |
| CH₃SiCl₃ | −928.3 |
| (CH₃)₃SiCl | −2733.8 |
| TiCl₄ | −553.4 |

Suitable combustion gases are hydrogen, methane, ethane, propane and/or natural gas, preference being given to hydrogen.

It may also be advantageous when the exit rate of the reaction mixture from the mixing chamber into the reaction chamber is 10 to 80 m/s.

The vapours of the silicon chloride and of the titanium tetrachloride can also be transferred into the mixing chamber by means of a carrier gas, in mixed form or separately.

The combustion gas, primary air and/or secondary air feedstocks can be introduced preheated. A suitable temperature range is 50 to 400° C.

In addition, primary and/or secondary air can be enriched with oxygen.

The process according to the invention can preferably be performed by using SiCl₄ as the silicon halide and TiCl₄ as the titanium halide, and in such a way that the adiabatic flame temperature T_{ad}=1100 to 1250° C.

The invention further provides a dispersion which has a pH of 9 to 14 and comprises the inventive pyrogenic silicon-titanium mixed oxide powder with a mean aggregate diameter of the silicon-titanium mixed oxide particles in the dispersion of less than 200 nm and water, where 5≦mol of water/mol of silicon-titanium mixed oxide≦30, preferably 10≦mol of water/mol of silicon-titanium mixed oxide≦20 and more preferably 12≦mol of water/mol of silicon-titanium mixed oxide≦17.

The pH of the dispersion can be adjusted by means of any bases soluble in the liquid phase of the dispersion. For example, KOH, NaOH, amines and/or ammonium hydroxides can be used. The dispersion preferably comprises a basic, quaternary ammonium compound. Particular preference is given to dispersions which comprise tetraalkylammonium hydroxides, for example tetraethylammonium hydroxide, tetra-n-propylammonium hydroxide and/or tetra-n-butyl-ammonium hydroxide.

The proportion of quaternary, basic ammonium compound in the inventive dispersion is not limited. If the dispersion is to be stored for a prolonged period, it may be advantageous to add to it only a proportion of the amount of the dispersion needed to prepare a titanium-containing zeolite. The quaternary, basic ammonium compound can preferably be added in such an amount as to result in a pH of 9 to 12. If the dispersion is, for example, to be used immediately after its preparation to prepare a titanium-containing zeolite, the dispersion may also already comprise the entire amount of quaternary, basic ammonium compound.

In that case, preferably, 0.005≦mol of ammonium compound/mol of silicon-titanium mixed oxide≦0.20, and, more preferably, 0.08≦mol of ammonium compound/mol of silicon-titanium mixed oxide≦0.17.

The invention further provides a process for preparing the inventive dispersion, in which
to a liquid phase which is circulated by means of a rotor/stator machine from a reservoir and is composed of water and one or more bases which are present in such an amount that the pH is 10 to 12,
by means of a filling apparatus, continuously or batchwise and with the rotor/stator machine running, such an amount of silicon-titanium mixed oxide powder according to Claims 1 to 5 is introduced into the shear zone between the slots of the rotor teeth and the stator slots so as to result in a dispersion with a content of silicon-titanium mixed oxide powder of 20 to 40% by weight, the pH being kept at 10 to 12 by continuous, further addition of the basic, quaternary ammonium compound, and
once all silicon-titanium mixed oxide powder has been added, the filling apparatus is closed and shearing is continued such that the shear rate is in the range between 10 000 and 40 000 s⁻¹, and
if appropriate, water and/or further base is then added in order to adjust the content of silicon-titanium mixed oxide powder and the pH.

The invention further provides a process for preparing a titanium-containing zeolite, in which the inventive silicon-titanium mixed oxide powder and a basic, quaternary ammonium compound are treated in an aqueous medium at a temperature of 150 to 220° C. over a period of less than 12 hours.

Preference is given to performing the process in such a way that 5≦mol of water/mol of silicon-titanium mixed oxide≦30. Particular preference is given to the range of 10≦mol of water/mol of silicon-titanium mixed oxide≦20 and very particular preference to that of 12≦mol of water/mol of silicon-titanium mixed oxide≦17.

It is also advantageous to perform the process in such a way that 0.005≦mol of ammonium compound/mol of silicon-titanium mixed oxide≦0.20. Particular preference is given to the range of 0.08≦mol of ammonium compound/mol of silicon-titanium mixed oxide≦0.17.

Basic, quaternary ammonium compounds serve as templates which determine the crystal structure by incorporation into the crystal lattice. Tetra-n-propylammonium hydroxide is preferably used for the preparation of titanium silicalite-1 (MFI structure), tetra-n-butylammonium hydroxide for the preparation of titanium silicalite-1 (MEL structure) and tetraethylammonium hydroxide for the preparation of titanium β-zeolites (BEA crystal structure).

The invention further provides a process for preparing a titanium-containing zeolite, in which the inventive dispersion, if appropriate with further addition of a basic, quaternary ammonium compound, is treated at a temperature of 150 to 220° C. over a period of less than 12 hours.

Under the above conditions of the process according to the invention, the crystallization time is usually less than 12 hours. The crystals are separated out by filtering, centrifuging or decanting and washed with a suitable wash liquid, preferably water. The crystals are then dried if required and calcined at a temperature between 400° C. and 1000° C., preferably between 500° C. and 750° C., in order to remove the template.

The particle fineness of less than 200 nm in the dispersion leads to a rapid dissolution of the particles and formation of the titanium-containing zeolites.

The invention further provides a titanium-containing zeolite which is obtainable by the process according to the invention proceeding from silicon-titanium mixed oxide powder.

The invention further provides a titanium-containing zeolite which is obtainable by the process according to the invention proceeding from the dispersion comprising silicon-titanium mixed oxide powder.

Both titanium-containing zeolites are obtained in powder form. For use as an oxidation catalyst, they are, if required, converted by known methods of shaping pulverulent catalysts, for example pelletization, spray-drying, spray-pelletization or extrusion, to a form suitable for use, for example to micropellets, spheres, tablets, solid cylinders, hollow cylinders or honeycomb.

The inventive titanium-containing zeolites can be used as catalysts in oxidation reactions with hydrogen peroxide. In particular, they can be used as catalysts in the epoxidation of olefins with the aid of aqueous hydrogen peroxide in a water-miscible solvent.

### EXAMPLES

Analysis:

BET surface area: the BET surface area is determined in DIN 66131.

DBP absorption: the dibutyl phthalate absorption is measured with a RHEOCORD 90 instrument from Haake, Karlsruhe.

To this end, 8 g of the powder, accurately to 0.001 g, are introduced into a kneading chamber which is closed with a lid and dibutyl phthalate is metered in at a defined metering rate of 0.0667 ml/s through a hole in the lid. The kneader is operated at a motor speed of 125 revolutions per minute. On attainment of the maximum torque, the kneader and the DPB addition are automatically switched off. The DPB absorption is calculated from the amount of DBP consumed and the amount of the particles weighed in according to:

DBP number (g/100 g)=(consumption of DBP in g/initial weight of particles in g)×100.

Feedstocks: The silicon tetrachloride and titanium tetrachloride feedstocks of Examples 1 to 5 have contents of Na, K, Fe, Co, Ni, Al, Ca and Zn of less than 50 ppm.

### Examples 1 to 4

### Titanium-Silicon Mixed Oxide Powders According to the Invention

### Example 1

6.0 kg/h of silicon tetrachloride and 0.26 kg/h of titanium tetrachloride are evaporated. The vapours are transferred into a mixing chamber by means of 15 m³ (STP)/h of nitrogen as a carrier gas. Separately therefrom, 3.3 m³ (STP)/h of hydrogen and 11.6 m³ (STP)/h of primary air are introduced into the mixing chamber. In a central tube, the reaction mixture is fed to a burner and ignited. The flame burns into a water-cooled flame tube. In addition, 13 m³ (STP)/h of secondary air and 0.5 m³ (STP)/h of peripheral hydrogen are introduced into the reaction chamber. The powder formed is separated out in a downstream filter and then treated in countercurrent with steam at 520° C.

Examples 2-4 are carried out analogously to Example 1 with the amounts listed in the table.

Example 5 is a comparative example whose composition is within the range of the silicon dioxide and titanium dioxide contents claimed, but has a significantly lower BET surface area than the powder claimed.

The substance parameters of the resulting powders are compiled in the table.

In all examples, the content of Na<10 ppm, K<10 ppm, Fe≦1 ppm, Co<1 ppm, Ni<1 ppm, Al<10 ppm, Ca <10 ppm, Zn<10 ppm.

TABLE
Feedstocks and amounts used, analytical values of
the silicon-titanium mixed oxide powder

| | | Example | | | | |
|---|---|---|---|---|---|---|
| | | 1 | 2 | 3 | 4 | 5 |
| SiCl₄ | kg/h | 6.0 | 6.0 | 6.0 | 5.15 | 5.15 |
| TiCl₄ | kg/h | 0.26 | 0.245 | 0.35 | 0.25 | 0.25 |
| H₂ core | m³ (STP)/h | 3.3 | 3.3 | 3.3 | 2.10 | 3.50 |
| H₂ | m³ (STP)/h | 0.5 | 0.5 | 0.5 | 1.0 | 1.1 |
| periph- | | | | | | |
| ery | | | | | | |
| Primary | m³ (STP)/h | 11.6 | 11.6 | 10.2 | 12.7 | 10.0 |
| air | | | | | | |
| Sec- | m³ (STP)/h | 13.0 | 14 | 13.0 | 15.0 | 15.1 |
| ondary | | | | | | |
| air | | | | | | |
| T_{ad} | ° C. | 1156 | 1124 | 1268 | 928 | 1308 |
| V_{Br} | m/s | 34 | 38 | 31 | 45 | 31 |
| BET | m²/g | 305 | 311 | 208 | 364 | 85 |
| DBP | g/100 g | 275 | 263 | 222 | 345 | 125 |
| number | | | | | | |
| DBP/ | g/100 g/m²/g | 0.9 | 0.85 | 1.07 | 0.95 | 1.47 |
| BET | | | | | | |
| SiO₂ | % by wt. | 95 | 95.5 | 94.5 | 94.5 | 94.5 |
| TiO₂ | 5 by wt. | 5 | 4.6 | 5.5 | 5.5 | 5.5 |

### Example 6

### Preparation of a Dispersion (Inventive)

A 100 l stainless steel mixing vessel is initially charged with 32.5 kg of demineralized water. Subsequently, a pH of approx. 11 is established with tetra-n-propylammonium hydroxide solution (TPAOH)(40% by weight in water). Then, with the aid of the suction nose of the Ystral Conti-TDS 4 (stator slots: 6 mm ring and 1 mm ring, rotor/stator distance approx. 1 mm), under shear conditions, 17.5 kg of the silicon-titanium mixed oxide powder from Example 1 are sucked in. During the suction of the powder, by further addition of the TPAOH, the pH is kept between 10 and 11 (the silicon-titanium mixed oxide powder used has an acidic character; 4 percent dispersion in water: pH approx. 3.6). After the suction has ended, the suction nozzle is closed, the pH is adjusted to 11 with TPAOH and the 33 percent by weight predispersion is sheared at 3000 rpm for another 10 min. Undesired heating of the dispersion as a result of the high energy input is countered by a heat exchanger and the temperature rise is restricted to max. 40° C.

In order to ensure a very high storage stability, the product is diluted with 25.8 kg of demineralized water and mixed thoroughly, and the pH of 11.0 is re-established once again with a little TPAOH.

Silicon-titanium mixed oxide concentration: 22% by weight. A total of 3.8 kg of tetra-n-propylammonium hydroxide solution (40% by weight in water) are used.

The dispersion has the following values:

Water/silicon-titanium mixed oxide 11.5

Mean aggregate diameter 92 nm (determined with Horiba LA 910)

### Example 6A

### Preparation of a Dispersion (Comparative)

A 100 l stainless steel mixing vessel is initially charged with 32.5 kg of demineralized water. Subsequently, with the aid of the suction nose of Ystral Conti-TDS 4 (stator slots: 6 mm ring and 1 mm ring, rotor/stator distance approx. 1 mm), under shear conditions, 13.6 kg of the silicon-titanium mixed oxide powder from Example 1 are sucked in.

This forms a dispersion having a content of silicon-titanium mixed oxide of 28% by weight, which possesses a high viscosity and a low stability.

The examples for the preparation of dispersions, 6 and 6A, show that, even though the inventive silicon-titanium mixed oxide powder consists predominantly of silicon dioxide, a dispersion technique known for silicon dioxide in the acidic pH range is not suitable for preparing extremely fine (<200 nm) and highly filled dispersions. Instead, the dispersion of the inventive silicon-titanium mixed oxide powder in the alkali range leads to a dispersion with the desired particle fineness and solids content.

A dispersion of pure silicon dioxide with comparable BET surface area, for example CAB-O-SIL® (H-5, from Cabot, BET surface area=300 m²/g), would not lead to the desired particle fineness and solids content under these conditions.

### Example 7

### Preparation of a Titanium-Containing Zeolite Proceeding from Silicon-Titanium Mixed Oxide Powder (Inventive)

A polyethylene beaker is initially charged with 137.0 g of a tetra-n-propylammonium hydroxide solution (40% by weight in water), and 434.2 g of deionized water and, with intensive stirring, 111.1 g of the pyrogenic silicon-titanium mixed oxide powder from Example 1 are incorporated. The resulting gel is first aged at 80° C. with intensive stirring for 2 hours and then crystallized in an autoclave at 180° C. for 10 hours. The resulting solid is removed from the mother liquor by centrifugation, washed three times with 250 ml each time of deionized water, dried at 90° C. and calcined in an air atmosphere at 550° C. for 4 hours.

Water/silicon-titanium mixed oxide 15.7

Tetrapropylammonium hydroxide/silicon-titanium mixed oxide 0.15

Example 8 (Comparative Example) is carried out analogously to Example 7, but using the silicon-titanium mixed oxide powder from Example 5. The incorporation of the powder requires significantly more time than in Example 7.

### Example 9

### Preparation of a Titanium-Containing Zeolite Proceeding from a Dispersion Comprising Silicon-Titanium Mixed Oxide Powder

A polyethylene beaker is initially charged with 505 g of the dispersion from Example 6, 46.7 g of deionized H₂O and 130.6 g of a tetra-n-propylammonium hydroxide solution (40% by weight in water) and first aged at 80° C. with stirring for 4 hours and then crystallized in an autoclave at 180° C. for 10 hours. The resulting solid is removed from the mother liquor by centrifuging, washed three times with 250 ml each time of deionized water, dried at 90° C. and calcined in an air atmosphere at 550° C. for four hours.

Water/silicon-titanium mixed oxide 15.6

Tetrapropylammonium hydroxide/silicon-titanium mixed oxide 0.14

The X-ray diffractogram of the crystals obtained from Examples 7 to 9 shows the diffraction pattern typical of the MFI structure, and the IR spectrum the characteristic band at 960 cm⁻¹. The UV-vis spectrum shows that the sample is free of titanium dioxide and titanates.

In the epoxidation of propylene with aqueous hydrogen peroxide solution, for the catalytic activity of the titanium silicalites obtained from Examples 7, 8 and 9: 9>7>>8.

1. A pyrogenic silicon-titanium mixed oxide powder, comprising
a BET surface area of 200 to 400 m²/g,
a ratio of DBP number/BET surface area of from 0.5 to 1.2, and
a silicon dioxide content of from 93.5 to 95.4% by weight and a titanium dioxide content of 4.6 to 6.5% by weight, where the sum of silicon dioxide content and titanium dioxide content is greater than 99.7% by weight, where all percentages are based on the total amount of the powder.

2. The pyrogenic silicon-titanium mixed oxide powder according to claim 1, wherein the BET surface area is from 250 to 350 m²/g.

3. The pyrogenic silicon-titanium mixed oxide powder according to claim 1, wherein the silicon dioxide content is 94 to 95% by weight and the titanium dioxide content is 5 to 6% by weight, and the sum of silicon dioxide content and titanium dioxide content is greater than 99.9% by weight.

4. The pyrogenic silicon-titanium mixed oxide powder according to claim 1, wherein the content of Al, Ca, Co, Fe, K, Na, Ni, and Zn is less than 50 ppm.

5. The pyrogenic silicon-titanium mixed oxide powder according to claim 1, wherein the content of chloride is less than 700 ppm.

6. A process for preparing the silicon-titanium mixed oxide powder according to claim 1, comprising
evaporating 93.5 to 95.4 parts by weight, calculated as SiO₂, of silicon halide and 4.6 to 6.5 parts by weight, calculated as TiO₂, of titanium halide are transferring the vapours into a mixing chamber,
transferring hydrogen combustion gas and primary air separately therefrom, into the mixing chamber,
igniting the mixture of the vapours of silicon halide and titanium halide, hydrogen combustion gas and primary air in a burner, and burning the flame into a reaction chamber,
introducing secondary air into the reaction chamber, then removing the solid from gaseous substances, and
freeing the solid of halide substances by a treatment with steam at temperatures of 250 to 700° C.,
wherein the amount of the feedstocks comprising silicon chloride, titanium chloride, combustion gas, primary air and secondary air is selected so as to result in an adiabatic flame temperature Tad for which 900° C.<T_{ad}<1300° C.,
where
T_{ad}=temperature of feedstocks+sum of the reaction enthalpies of the subreactions/heat capacity of the substances which leave the reaction chamber including silicon dioxide, water, hydrogen chloride, carbon dioxide, oxygen, nitrogen, or the carrier gas if it is not air or nitrogen, or mixtures thereof, the basis being the specific heat capacity of these substances at 1000° C.

7. The process according to claim 6, wherein the silicon halide is SiCl₄, the titanium halide is TiCl₄, and T_{ad}=1050±50° C.

8. The process according to claim 6, wherein the outflow rate v_{Br} of the gases from the burner into the reaction chamber is from 10 to 80 m/s.

9. A dispersion which has a pH of from 9 to 14 and comprises the pyrogenic silicon-titanium mixed oxide powder according to claim 1 with a mean aggregate diameter of the silicon-titanium mixed oxide particles in the dispersion of less than 200 nm and water, where 5≦of water/mol of silicon-titanium mixed oxide ≦30.

10. The dispersion according to claim 9, further comprising a basic, quaternary ammonium compound.

11. The dispersion according to claim 10, comprising 0.005≦mol of ammonium compound/mol of silicon-titanium mixed oxide<0.20.

12. A process for preparing the dispersion according to claim 9, comprising
adding to a liquid phase which is circulated by means of a rotor/stator machine from a reservoir and is composed of water and one or more bases which are present in such an amount that the pH is 10 to 12,
by means of a filling apparatus with the rotor/stator machine running, such an amount of silicon-titanium mixed oxide powder according to claim 1 into the shear zone between the slots of the rotor teeth and the stator slots so as to result in a dispersion with a content of silicon-titanium mixed oxide powder of 20 to 40% by weight, the pH being kept at 10 to 12 by continuous, further addition of the basic, quaternary ammonium compound, and
once all silicon-titanium mixed oxide powder has been added, closing the filling apparatus and shearing is continued such that the shear rate is in the range between 10 000 and 40 000 s⁻¹.

13. A process for preparing a titanium-zeolite, comprising treating the silicon-titanium mixed oxide powder according to claim 1 and a basic, quaternary ammonium compound in an aqueous medium at a temperature of 150 to 220° C. over a period of less than 12 hours.

14. The process according to claim 13, comprising 5≦mol of water/mol of silicon-titanium mixed oxide≦30.

15. The process according to claim 13, comprising 0.005≦mol of ammonium compound/mol of silicon-titanium mixed oxide<0.20.

16. A process according to claim 13, wherein the basic, quaternary ammonium compound is a tetraalkylammonium hydroxide.

17. The process for preparing a titanium-containing zeolite, comprising treating the dispersion according to claim 9, if appropriate with further addition of a basic, quaternary ammonium compound, at a temperature of from 150 to 220° C. over a period of less than 12 hours.

18. The process according to claim 13, wherein the titanium-containing zeolite is removed, dried and calcined.

19. A titanium zeolite obtainable by the process according to claim 13.

20. A titanium zeolite obtainable by the process according to claim 17.

21. (canceled)

22. The process according to claim 12, wherein water and/or further base is then added in order to adjust the content of silicon-titanium mixed oxide powder and the pH.

23. A titanium zeolite obtainable by the process according to claim 16.

24. A titanium zeolite obtainable by the process according to claim 18.

25. A titanium zeolite obtainable by the process according to claim 17.

26. A catalyst comprising the titanium zeolite according to claim 19.
